(19) United States
(12) Patent Application Publication
(10) Pub. No.: US 2016/0063376 A1
(43) Pub. Date: Mar. 3, 2016

(54) OBTAINING USER TRAITS

(71) Applicant: International Business Machines Corporation, Armonk, NY (US)

(72) Inventors: Hang Chen, Yueyang City (CN); Lin Luo, Beijing (CN); Ying-xin Pan, Beijing (CN); Ke Feng Shao, Beijing (CN); Shiwan Zhao, Beijing (CN)

(21) Appl. No.: 14/823,296

(22) Filed: Aug. 11, 2015

(30) Foreign Application Priority Data
Aug. 29, 2014 (CN) 201410437643.2

(51) Int. Cl. G06N 5/02; G06Q 50/00

(52) U.S. Cl. CPC G06N 5/022; G06Q 50/01

(57) ABSTRACT

A method for obtaining user traits. In response to a first kind of data of a target user not being sufficient to obtain a trait of the target user, a second kind of data of the target user is collected, where the first kind of data and the second kind of data are different kinds of data. Based on the second kind of data, one or more reference users similar to the target user are determined. Based on the first kind of data of the reference users, the trait of the target user is determined.

### BACKGROUND

The present invention relates generally to a method for obtaining user traits.

With the development of intelligent computing, in a web environment, more and more computing services provide personalized and intelligent services based on traits of individual users. Such user traits-based services are beneficial to promoting user satisfaction, enhancing user experience, and improving user operation efficiency. The basis for this service is accurately obtaining the user traits. Examples of the user traits include, but are not limited to, the user's personality features, the user's general behavior habits, the user's behavior habits when performing a particular task, the user's recognition traits, the user's social background, demographical features, and the like.

Traditionally, obtaining user traits depended on manual input. For example, a user might be required to fill in a predefined form. However, this method increases the user's burden and lacks flexibility. It has been proposed to obtain user traits by learning a user's behaviors. For example, the user's traits could be discovered and learned from the historical behaviors of the user, the most common historical behavior data being information input by the user, for example, text information. However, such information is necessarily limited in quantity and is generally insufficient to obtain accurate and complete user traits. In some cases, tasks do not allow the user to input any information. Insufficient or complete lack of available sample information represent challenges to obtaining user traits.

### SUMMARY

Embodiments of the present invention disclose a computer-implemented method, system, and computer program product for obtaining user traits. In response to a first kind of data of a target user not being sufficient to obtain a trait of the target user, a second kind of data of the target user is collected, the first kind of data and the second kind of data being different kinds of data. Based on the second kind of data, one or more reference users similar to the target user are determined. The trait of the target user is obtained, based on the first kind of data of the reference users.

According to embodiments of the present invention, different kinds of data are integrally combined together. Even if the primary data of the target user is insufficient or missing, one or more user traits of the target user can be accurately estimated by virtue of relevant data of other similar users, thereby allowing provision of personalized and intelligent services for the target user. Other features and advantages of the present invention will become easily comprehensible through the description below.

### BRIEF DESCRIPTION OF THE DRAWINGS

Through the more detailed description of some embodiments of the present disclosure in the accompanying drawings, the above and other objects, features and advantages of the present disclosure will become more apparent.

FIG. 1 shows an exemplary computer system/server which is applicable to implementing embodiments of the present invention.

FIG. 2 shows a schematic flow diagram of a method for obtaining user traits according to an embodiment of the present invention.

FIG. 3 shows a schematic flow diagram of a method for obtaining user traits based on a first kind of data containing textual data according to an embodiment of the present invention.

FIG. 4 shows a schematic flow diagram of a method for obtaining user traits according to an embodiment of the present invention.

FIG. 5 shows a schematic block diagram of a system for obtaining user traits according to an embodiment of the present invention.

In respective figures, same or like reference numerals are used to represent the same or like components.

### DETAILED DESCRIPTION

Some preferable embodiments will be described in more detail with reference to the accompanying drawings, where the preferable embodiments of the present disclosure have been illustrated. However, the present disclosure can be implemented in various manners, and thus should not be construed to be limited to the embodiments disclosed herein. On the contrary, those embodiments are provided to aid in understanding the present disclosure, and to convey the scope of the present disclosure to those skilled in the art.

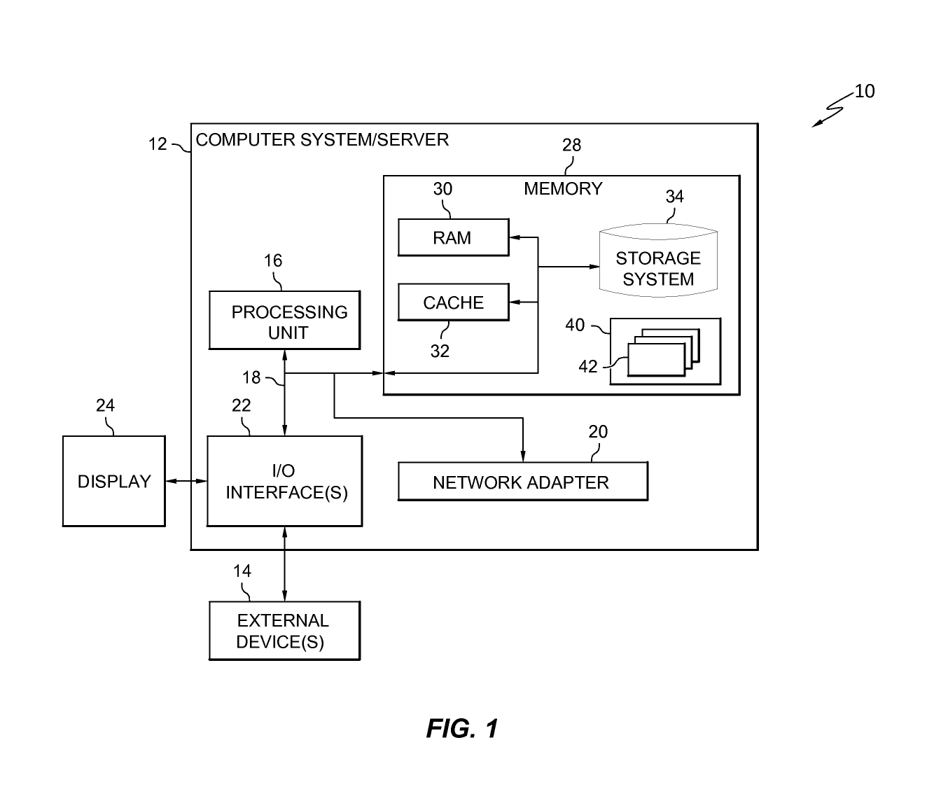

FIG. 1 shows an exemplary computer system/server 12 which is applicable to implementing embodiments of the present invention. Computer system/server 12 is only illustrative and is not intended to suggest any limitation as to the scope of use or functionality of embodiments of the invention described herein.

As shown in FIG. 1, computer system/server 12 is shown in the form of a general-purpose computing device. The components of computer system/server 12 include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media can be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 can further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 can include at least one program product having a set (e.g., at least one) of program modules that are configured to carry out the functions of embodiments of the invention.

Program/utility 40, having a set (at least one) of program modules 42, can be stored in memory 28 by way of example, and not limitation, as well as an operating system, one or more application programs, other program modules, and program data. Each of the operating system, one or more application programs, other program modules, and program data or some combination thereof, can include an implementation of a networking environment. Program modules 42 generally carry out the functions and/or methodologies of embodiments of the invention as described herein.

Computer system/server 12 can also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Additionally, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

Hereinafter, the mechanism and principle of embodiments of the present invention will be described in detail. Unless otherwise stated, the term “based on” used hereinafter and in the claims expresses “at least partially based on.” The term “comprise” or “include” or a similar expression indicates an open inclusion, i.e., “including, but not limited to . . . .” The term “plural” or a similar expression indicates “two or more.” The term “one embodiment” indicates “at least one embodiment.” The term “another embodiment” indicates “at least one another embodiment.” Definitions of other terms will be provided in the following description.

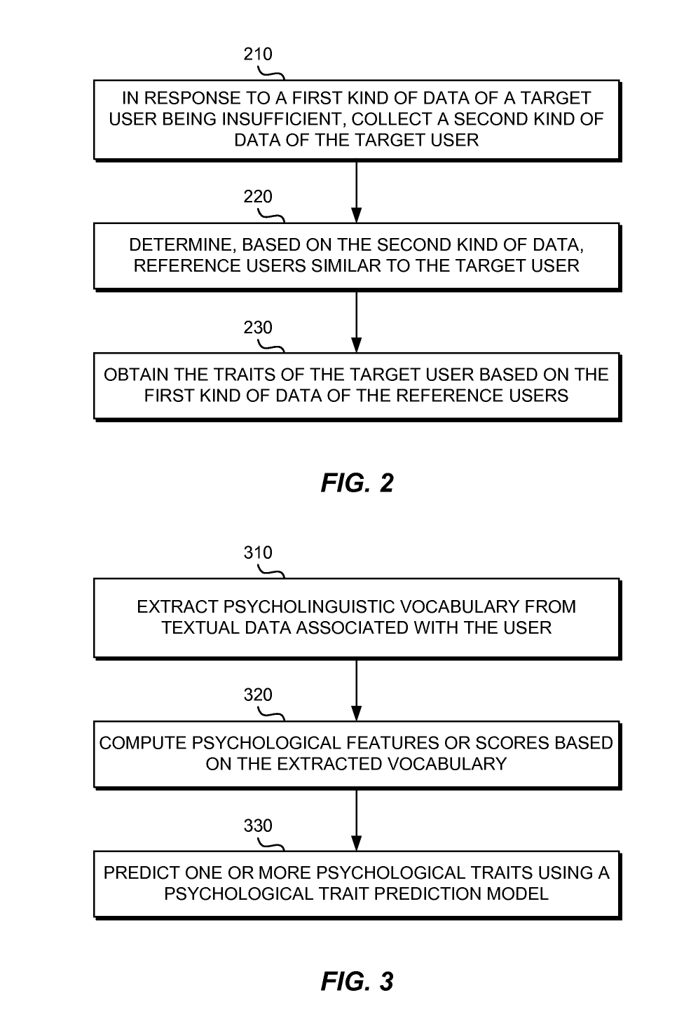

FIG. 2 shows a schematic flow diagram of a method 200 for obtaining user traits according to embodiments of the present invention. In the description below, for the convenience of discussion, the user currently under consideration is called a “target user.” In other words, the method 200 is performed for obtaining one or more traits of the target user. Moreover, according to various embodiments of the present invention, the method 200 is used to dynamically obtain the traits of the target user while he/she is operating in a web environment, so as to realize online trait obtaining. Alternatively or additionally, historical operation data of the user in the web environment can also be used to obtain the traits, thereby realizing offline trait obtaining.

The term “traits” as used herein refers to any information describing the habits or preferences in aspects of a user's personalities, behaviors, psychologies, cognitions, etc. For example, in one embodiment, the user's traits include the user's various personality traits. These personality traits can be used to enhance the intelligence and flexibility of computing services, thereby improving user experience and operational efficiency. For example, in one embodiment, the user traits comprise one or more personality traits in the “Big Five Personality.” The “Big Five Personality” refers to a person's openness, conscientiousness, extraversion, agreement, and neuroticism. These personality traits are usually significant for applications in a web environment such as a social network.

As shown in FIG. 2, method 200 starts from step 210. For any user to be processed (called “target user”), a second kind of data of the target user is obtained in response to determining that a first kind of data of the target user is insufficient for determining the user's traits.

The term “the first kind of data” used herein refers to data that can be used independently to obtain user traits. For example, in one embodiment, the first kind of data includes textual data describing a text associated with the user. For example, the textual data can comprise commentaries, posts, replies, or various other forms of comments published for a specific content or object when the user is browsing a social network website, blog, Weibo, or other website. For example, after a specific code segment is downloaded from a website providing open source program code, the user can comment on the quality of the downloaded code segments on the website, e.g., its programming style, annotation style, etc.

Alternatively or additionally, the textual data acting as the first kind of data can also comprise any other texts associated with the target user, e.g., one or more of the following texts describing the target user: background, interests, work unit, home address, etc. Such textual information can be provided by the target user and is maintained by the corresponding website. For example, the profile for the target user is maintained.

In some embodiments, as described below, the textual data is used as an example of the first kind of data. However, it should be understood that this is for the sake of illustration, and is not intended to limit the scope of the present invention. In addition to the textual data, or as an alternative, the first kind of data can comprise other types of data, e.g., data describing the user's behavior or actions, etc.

If the first kind of data of the target user is sufficient to obtain the traits of the target user, one or more traits of the user can be obtained directly based on the first kind of data. For example, in an embodiment in which the first kind of data contains textual data, the psycholinguistic vocabulary contained in the text, one or more personality traits of the target user are predicted based on the psycholinguistic vocabulary contained in the text. FIG. 3 shows a flow diagram of an exemplary method 300 with this aspect.

The method 300 starts from step 310, where psycholinguistic vocabulary is extracted from textual data associated with the user. The text associated with the user can, for example, be text previously input by the user. In one embodiment, the psycholinguistic vocabulary is predefined. Next, in step 320, a psycholinguistic feature or score is computed, based on the extracted vocabulary. In one embodiment, a correspondence relationship between different psycholinguistic vocabularies and psychological features or scores is predefined and stored. By matching the psycholinguistic vocabularies extracted in step 310 and the vocabularies in the predefined correspondence relationship, the psychological feature and/or score of the target user are determined. With these features or scores, in step 330, a psychological trait prediction model is used to predict one or more psychological traits of the user as user traits. Such psychological prediction models are known, and will not be detailed here so as not to confuse the purpose of the present invention.

It should be understood that the method 300 is only an exemplary embodiment of obtaining user traits based only on a first kind of data, which does not intend to limit the scope of the present invention. Any other appropriate method could be employed to obtain user traits. For example, in an alternative embodiment, a direct association relationship between textual data (e.g., keywords) and user traits is established through experiment. In such an embodiment, keywords are extracted from textual data previously input by the user. Then, through keyword matching, one or more features of the user are directly determined, based on a predefined association relationship. Other embodiments are possible, and the scope of the present invention is not limited to this aspect.

Continuing to FIG. 2, in step 210, if it is determined that the first information of the target user does not suffice to obtain his/her traits, a second kind of data of the target user will be collected. According to embodiments of the present invention, the second kind of data and the first kind of data are different kinds of data, which describe different aspects of the target user. For example, in an embodiment in which the first kind of data includes textual data, the second kind of data could include behavior data, which describes one or more historical behaviors of the target user.

It will be appreciated that actions data is generally richer than textual data and therefore is relatively easier to obtain. For example, when browsing a website, some users only perform browsing without publishing comments. As another example, some websites do not allow the user to publish textual information at all. In this instance, there can be insufficient or even a complete lack of textual data. However, data describing browsing behaviors, interactive actions, and browsing history in browsing websites can be collected and stored as behavior data. In this way, even if not enough textual data can be collected, richer behavior data can still be collected.

In the following description of various embodiments, behavior data is used as an example of the second kind of data. However, it should be noted that the second kind of data is not limited to behavior data. In some cases, the textual information of the user is likely to be richer than the behavior data. As an example, for a social network, this is quite likely to happen, as the main purpose of a user using a social network is to interact with other persons, rather than simply to browse content. Correspondingly, in one embodiment, the behavior data is used as the first kind of data, while the textual data is used as the second kind of data.

Next, the method 200 proceeds to step 220, where, based on the second kind of data collected in step 210, one or more reference users similar to the target user are determined. As an example, as stated above, the second kind of data can include behavior data. In such an embodiment, one or more historical behaviors of the target user can be determined based on the second kind of data. If the historical behaviors of a candidate user are close enough to the historical behaviors of the target user, this candidate user can be designated as a reference user.

Solely for the purpose of description, a specific example is now considered. Suppose the second kind of data of the target user collected in step 210 includes data involving the following behaviors: (1) downloading, by the user, one or more program code segments on a website providing open source program code; (2) rating or scoring the program code segment downloaded by the target user. At this point, for a given candidate user, the behavior data of the candidate user can be collected, which describes the program code segment downloaded by the candidate user from the website. Based on the behavior data of the target user and the candidate user, the overlap between the program code segments downloaded by these two users can be determined. In one embodiment, it is possible to quantize the number or proportion of overlap as a score, called a “download score.” The download score indicates a similarity between the target user and the candidate user in the aspect of “download” behavior. A “rating score” can be obtained in a similar way. In one embodiment, an operation such as averaging or weighted averaging is performed on various scores, and the result function as the similarity score between the target user and the candidate user. If the similarity score exceeds a predetermined threshold, indicating that the target user and the candidate user have enough similarity in terms of these behaviors, then the candidate user can be selected as a reference user.

In particular, in step 220, a reference user similar to the target user can be selected from various different candidate user groups. In one embodiment, some or all of the reference users are determined from “seed users.” The term “seed user” refers to users with enough of he first kind of data. In other words, the first kind of data for each seed user is sufficient to independently obtain or predict one or more user traits. For example, in an embodiment in which the first kind of data includes textual data, the textual quantity (e.g., measured by the number of characters) associated with the seed users exceeds a predetermined threshold and is therefore sufficient to predict one or more traits of the user.

Alternatively or additionally, in one embodiment, a reference user similar to the target user is selected from “non-seed users.” The term “non-seed users” refers to those users who individually do not have enough of the first kind of data. In other words, for each non-seed user, the data quantity of the associated first kind of data does not suffice to independently obtain user traits. For example, in the embodiment described in which the first kind of data includes textual data, the textual quantity associated with non-seed users is lower than a predetermined threshold, such that the user's traits cannot be accurately predicted.

According to various embodiments of the present invention, seed users and non-seed users are used in combination in different ways. For example, in one embodiment, seed users similar to the target user are first sought. If found, these seed users are designated as reference users, with no further consideration of non-seed users. On the other hand, if seed users similar to the target user are not found, reference users similar to the target user will be sought among the non-seed users. Alternatively, in another embodiment, reference users similar to the target user are determined from the seed and non-seed users. At this point, the reference users determined in step 220 can include both the seed and non-seed users.

Method 200 proceeds to step 230, where traits of the target user are obtained, based on the first kind of data of the reference users who were determined in step 220. Generally, since the reference users and the target user have a relatively high degree of similarity, it is reasonable to deem that the traits of the reference users, reflected by the first kind of data of the reference users, are similar to the traits of the target user as well.

Specifically, in one embodiment, if reference users include one or more seed users, based on the first kind of data of each seed user, the traits of the seed user are obtained. For example, trait obtaining based on the first kind of data can be implemented using the method 300, as described with reference to FIG. 3. Then, these traits are combined, for example, the values of traits of respective seed users are averaged, weighted averaged, or summed, etc., and the result is used as the trait of the target user. Alternatively, the first kind of data of different seed users is first combined, and then the combined first kind of data is used to obtain user traits. In particular, in an embodiment employing a weighted average, the weight for each seed user can be determined based on the similarity between the seed user and the target user.

On the other hand, if the reference users include one or more non-seed users, because the first kind of data of each non-seed user individually do not suffice to obtain traits, the first kind of data of these non-seed users can be aggregated. For example, the textual data of the non-seed users can be aggregated. Next, user traits can be generated based on the aggregated textual data. Aggregation of the first kind of data can be performed based on the similarity between non-seed users, for example. Embodiments with this aspect will be described below.

By performing method 200, embodiments of the present invention can integrally combine different kinds of data (e.g., textual data and behavior data). In this way, even if the main kind of data is insufficient or missing, traits of the target user can still be accurately obtained by virtue of other users. Based on these traits, the intelligence of service provided to users can be enhanced.

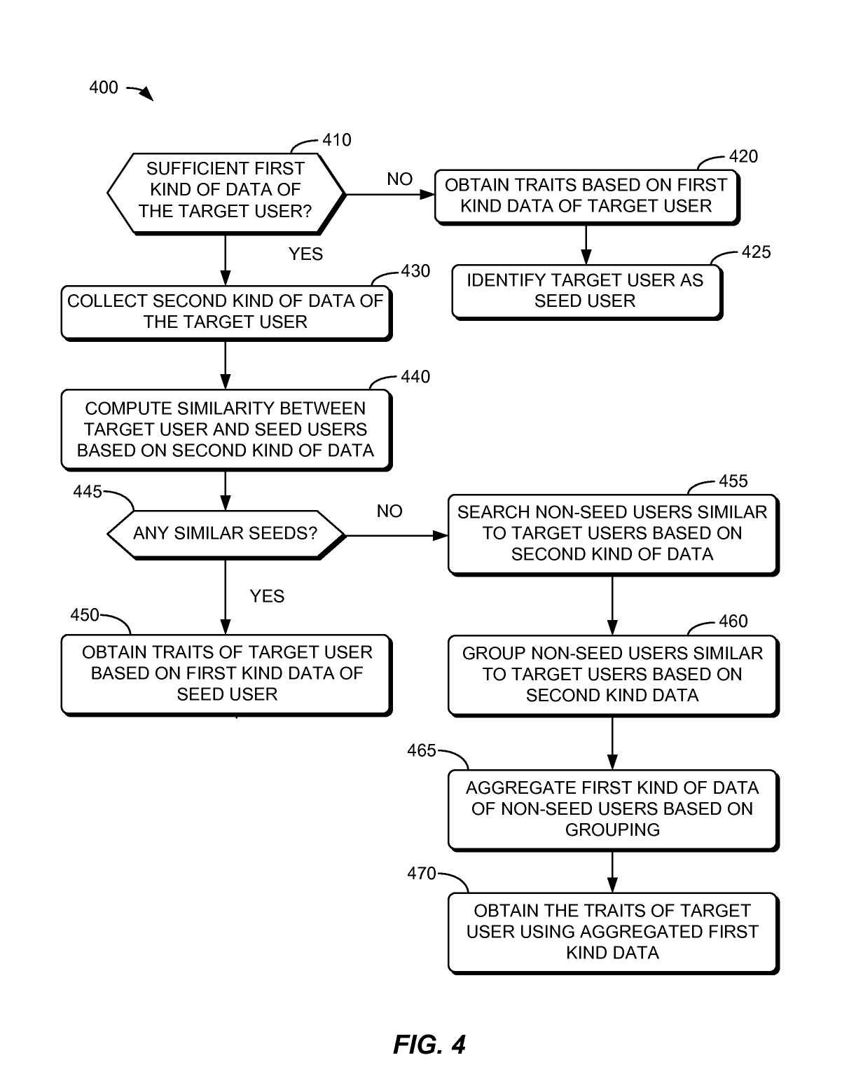

Hereinafter, refer to FIG. 4, where a flow diagram of a method 400 for obtaining user traits according to one embodiment of the present invention is shown. The method 400 can be regarded as an exemplary specific implementation of the method 200 as described above.

The method 400 starts from step 410, where it is determined whether a target user has sufficient data of the first kind. If so, in step 420, one or more traits of the target user are obtained, based on the first kind of data. The details of step 410 and step 420 have been described above with reference to the method 200, and will not be presented here.

In particular, after step 420, the method 400 proceeds to step 425, where the first kind of data and any relevant information on the target user are stored. In this way, the target user can be identified as a seed user. Information regarding the seed user can be stored, for example, in a dedicated storage called a “seed repository,” for use in obtaining traits of one or more further users in the future.

On the other hand, if it is determined in step 410 that the first kind of data of the target user is insufficient to obtain the user traits, the method 400 proceeds to step 430, where the second kind of data of the target user (e.g., behavior data) is collected. The details of step 430 have been described above with reference to method 200, and will not be presented here.

Next, in step 440, a similarity between the target user and one or more seed users is computed, based on the second kind of data. To this end, the second kind of data (e.g., behavior data) of the seed users also needs to be collected. In one embodiment, the second kind of data of the seed users is stored in a specific seed database in association with corresponding seed data. The embodiment of the similarity computing method has been described above with reference to method 200, and will not be detailed here.

Then, in step 445, it is judged whether there is at least one seed user whose similarity with the target user exceeds a predetermined threshold. If it is determined in step 445 that there are one or more seed users who are sufficiently similar to the target user, these seed users can be designated as reference users. Accordingly, the method 400 proceeds to step 450, where the traits of the target user are obtained, based on the first kind of data of the seed users. For example, values of one or more traits can be computed based on the first kind of data of each seed user. Next, operations such as weighted averaging can be performed on these trait values, thereby obtaining the trait values of the target user. Alternatively, in some other embodiments, the first kind of data of respective seed users is first aggregated (e.g., via a weighted average), and then the traits of the target user are obtained using the aggregated first kind of data.

In particular, the contribution of each seed user in the process of obtaining the traits of the target user can be determined flexibly. For example, in an embodiment in which the traits of the target user are obtained using a weighted average, the contribution of each seed user is employed as the weight of the corresponding seed user in the weighted average. According to various embodiments of the present invention, the weight for a respective seed user is determined based on various appropriate factors. For example, as mentioned above, in one embodiment, the weight is determined based on a similarity between a seed user and a target user.

In particular, in one embodiment, for a given seed user (called “a first seed user”) among the reference users, a deviation degree between the first seed user and other seed users among the reference users is determined, based on the first kind of data and/or the second kind of data. The deviation degree is used to weigh the irregularity of the first seed user in one or more trait dimensions.

As an example, consider an embodiment, in which the second kind of data includes a user's rating data for a specific program code segment on a website providing program source code. If it is found that a seed user's rating for a given program code segment is apparently higher or lower than the rating of other seed user for the program code segment, it can be assumed that the agreement of the first seed user is likely an aberration. For example, when the agreement of the first user is relatively low, his/her rating of the program code segment is likely always lower than other users.

At this point, for the dimension “agreement” in the personality traits, the first seed user apparently deviates from other seed users among the reference users. Correspondingly, when obtaining the traits of the target user based on the first kind of data of the seed users, the weight of the first seed user for the “agreement” dimension can be adjusted downward appropriately. In this way, the peculiarity of the first seed user on the “agreement” dimension can be compensated appropriately. Similarly, the contribution of the corresponding seed user to a corresponding trait dimension in trait obtaining can be adjusted based on the first kind of data and/or second kind of data.

Returning to step 445, if it is determined that a seed user similar to the target user does not exist in this step, the method 400 proceeds to step 455, where reference users similar to the target user are sought among the non-seed users. The similarity between the non-seed users and the target user can be likewise determined based on the second kind of data.

As mentioned above, the first kind of data of each individual non-seed user does not suffice to obtain any trait. Therefore, in one embodiment, the first kind of data is expanded by aggregating the first kind of data of a plurality of non-seed users so as to satisfy the needs of trait obtaining. Specifically, in step 460, the non-seed users among the reference users are grouped based on the second kind of data. For example, in one embodiment, a clustering process can be applied to these non-seed users such that the following non-seed users are aggregated together, the similarity of the second kind of data of those aggregated non-seed users is greater than a predetermined threshold. Note that according to embodiments of the present invention, the similarity threshold used in step 460 can be identical to or different from the similarity threshold used in step 445.

Next, in step 465, the first kind of data of the non-seed users is aggregated based on the grouping. Specifically, the first kind of data of the non-seed users belonging to the same group is aggregated. For example, in an embodiment where the first kind of data includes textual data, the textual data associated with all non-seed users within the same group is aggregated. In one embodiment, the union the texts of these non-seed users is used to obtain the aggregated text. In this way, there will be no repeated content in the aggregated text.

In step 470, traits of the target user are obtained based on the aggregated first kind of data. It will be appreciated that through aggregation of the first kind of data, aggregation of the first kind of data of the non-seed users belonging to the same group very likely become sufficient to obtain or predict user traits. If so, this group can be regarded as a special seed user, and the user traits can be obtained in a manner similar to step 450.

Through the above process, even if the first kind of data of the target user misses (branch “No” in step 410) and a seed user similar to the target user does not exist (branch “No” in step 445), traits of the target user can still be obtained successfully through aggregating the first kind of data of the non-seed users similar to the target user.

It should be understood that the method 400 is only an exemplary possible implementation, not intending to limit embodiments of the present invention in any manner. For example, in one embodiment, instead of searching for a similar non-seed user when a similar seed user cannot be found, the reference users include both seed users and non-seed users. At this point, not only can the first kind of data be aggregated for non-seed users, as shown in FIG. 4, but the first kind of data of non-seed users can also be aggregated with the first kind of data of similar seed users. Based on the teaching of the present disclosure, those skilled in the art can also envisage other possible variations that fall within the scope of the present invention.

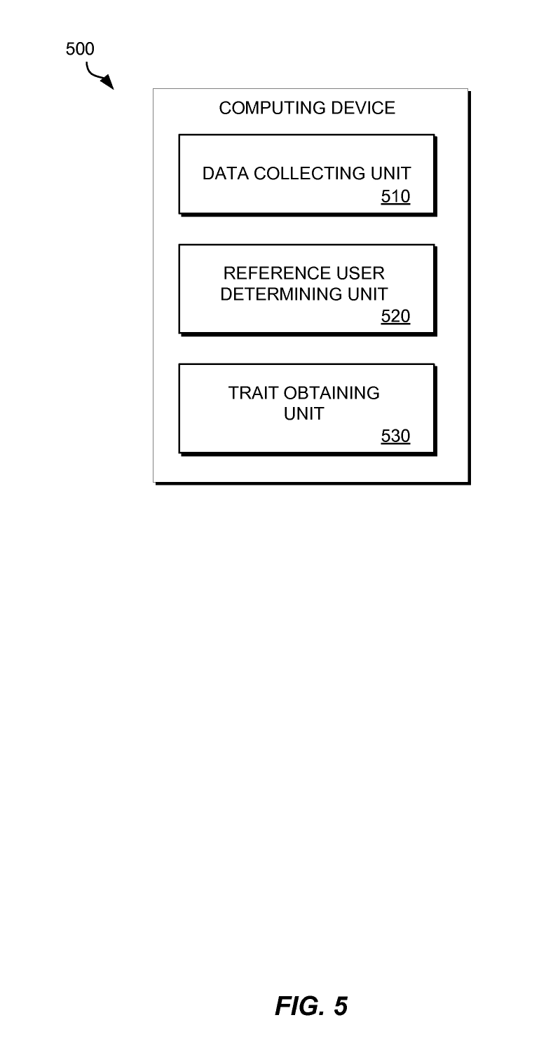

FIG. 5 shows a schematic block diagram of a system for obtaining user traits, according to various embodiments of the present invention. As shown in FIG. 5, the system 500 for obtaining user traits comprises: a data collecting unit 510 configured to, in response to a first kind of data of a target user being not sufficient to obtain a trait of the target user, collect a second kind of data of the target user, the first kind of data and the second kind of data being different kinds of data; a reference user determining unit 520 configured to determine, based on the second kind of data, one or more reference users similar to the target user; and a trait obtaining unit 530 configured to obtain the trait of the target user based on the first kind of data of the reference users.

In one embodiment, the first kind of data of the target user includes textual data that describes a text associated with the target user. In this case, the data collecting unit 510 can comprise: a behavior data collecting unit configured to collect behavior data of the target user, the behavior data describing historical behaviors of the target user.

In one embodiment, the reference user determining unit 520 comprises: a first determining unit configured to determine users having a behavior similar to the target user as the candidate users based on the behavior data.

In one embodiment, the reference user determining unit 520 comprises: a second determining unit configured to determine the reference users from seed users, the first kind of data of each of the seed user being sufficient to obtain the feature. In such an embodiment, the trait obtaining unit 530 can comprise: a deviation degree determining unit configured to determine a deviation degree between a first seed user among the reference users and other seed users among the reference users based on at least one of the first kind of data and the second kind of data; and a contribution adjusting unit configured to in response to determining that the deviation degree exceeds a predetermined threshold, adjust contribution of the first kind of data of the first seed user to the obtaining of the trait.

In one embodiment, the reference user determining unit 520 comprises: a third determining unit configured to determine the reference users from non-seed users, the first kind of data of each of the non-seed users being insufficient to obtain the trait. In such an embodiment, the trait obtaining unit 530 can comprise: a user grouping unit configured to group non-seed users among the reference users based on the second kind of data; and a data aggregating unit configured to aggregate the first kind of data of the non-seed users among the reference users based on the grouping. Correspondingly, the trait obtaining unit 530 can be configured to obtain the trait based on the aggregated first kind of data.

In one embodiment, the system 500 can further comprise: a seed user identifying unit configured to identify the target user as a seed user through storing relevant information regarding the target user and the trait, so as to be available in obtaining the trait of other users.

It should be noted that for the sake of clarity, FIG. 5 does not show optional units or sub-units included in the apparatus 500. All features and operations as described above are suitable for apparatus 500, respectively, which are therefore not detailed here. Moreover, partitioning of units or subunits in apparatus 500 is exemplary, rather than limitative, intended to describe its main functions or operations logically. A function of one unit can be implemented by a plurality of other units; on the contrary, a plurality of units can be implemented by one unit. The scope of the present invention is not limited in this aspect.

Moreover, the units included in the apparatus 500 can be implemented in various ways, including software, hardware, firmware, or a combination thereof. For example, in some embodiments, the apparatus is implemented by software and/or firmware. Alternatively or additionally, the apparatus 500 can be implemented partially or completely based on hardware, for example, one or more units in the apparatus 500 can be implemented as an integrated circuit (IC) chip, an application-specific integrated circuit (ASIC), a system on chip (SOC), a field programmable gate array (FPGA), etc. The scope of the present intention is not limited to this aspect.

The present invention can be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The foregoing description of various embodiments of the present invention has been presented for purposes of illustration and description. It is not intended to be exhaustive nor to limit the invention to the precise form disclosed. Many modifications and variations are possible. Such modification and variations that may be apparent to a person skilled in the art of the invention are intended to be included within the scope of the invention as defined by the accompanying claims.

What is claimed is:

1. A computer-implemented method of obtaining user traits, the method comprising:
in response to determining, by a computer, that a first kind of data of a target user is not sufficient to obtain a trait of the target user, collecting, by the computer, a second kind of data of the target user, wherein the first kind of data and the second kind of data are different kinds of data;
determining, by the computer, based on the second kind of data, one or more reference users similar to the target user; and
obtaining, by the computer, the trait of the target user based on the first kind of data of the reference users.

2. A method in accordance with claim 1, wherein the first kind of data of the target user includes textual data that describes a text associated with the target user, and wherein collecting the second kind of data of the target user comprises:
collecting, by the computer, behavior data of the target user, the behavior data describing historical behaviors of the target user.

3. A method in accordance with claim 2, wherein determining one or more reference users similar to the target user comprises:
determining, by the computer, users having similar behaviors to the target user as the reference users based on the behavior data.

4. A method in accordance with claim 1, wherein determining one or more reference users similar to the target user comprises:
determining, by the computer, the reference users from seed users, wherein each of the seed users is a user having the first kind of data sufficient to obtain the trait.

5. A method in accordance with claim 4, wherein obtaining the trait of the target user based on the first kind of data of the reference users comprises:
determining, by the computer, based on at least one of the first kind of data and the second kind of data of seed users in the reference users, a deviation degree between a first seed user in the reference users and other seed users in the reference users; and
in response to determining that the deviation degree exceeds a predetermined threshold, adjusting, by the computer, a contribution of the first kind of data of the first seed user to the obtaining of the trait.

6. A method in accordance with claim 1, wherein determining one or more reference users similar to the target user comprises:
determining, by the computer, the reference users from non-seed users, wherein each of the non-seed users is a user with the first kind of data insufficient to obtain the trait.

7. A method in accordance with claim 6, wherein obtaining the trait of the target user based on the first kind of data of the reference users comprises:
grouping, by the computer, non-seed users in the reference users based on the second kind of data of the non-seed users in the reference users;
aggregating, by the computer, the first kind of data of the non-seed users in the reference users based on the grouping; and
obtaining, by the computer, the trait based on the aggregated first kind of data.

8. A method in accordance with claim 1, further comprising:
in response to determining, by the computer, that the first kind of data of the target user is sufficient to obtain the trait of the target user, storing, by the computer, the first kind of data of the target user for use in obtaining the trait of a further user.

9. A computer system for obtaining traits, the computer system comprising:
one or more computer processors, one or more computer-readable storage media, and program instructions stored on one or more of the computer-readable storage media for execution by at least one of the one or more processors, the program instructions comprising:
program instructions, in response to determining, by a computer, that a first kind of data of a target user is not sufficient to obtain a trait of the target user, to collect a second kind of data of the target user, wherein the first kind of data and the second kind of data are different kinds of data;
program instructions to determine, based on the second kind of data, one or more reference users similar to the target user; and
program instructions to obtain the trait of the target user based on the first kind of data of the reference users.

10. A computer system in accordance with claim 9, wherein the first kind of data of the target user includes textual data that describes a text associated with the target user, and wherein program instructions to collect the second kind of data of the target user comprise:
program instructions to collect behavior data of the target user, the behavior data describing historical behaviors of the target user.

11. A computer system in accordance with claim 10, wherein program instructions to determine one or more reference users similar to the target user comprise:
program instructions to determine users having similar behaviors to the target user as the reference users based on the behavior data.

12. A computer system in accordance with claim 9, wherein program instructions to determine one or more reference users similar to the target user comprise:
program instructions to determine the reference users from seed users, wherein each of the seed users is a user having the first kind of data sufficient to obtain the trait.

13. A computer system in accordance with claim 12, wherein program instructions to obtain the trait of the target user based on the first kind of data of the reference users comprise:
program instructions to determine, based on at least one of the first kind of data and the second kind of data of seed users in the reference users, a deviation degree between a first seed user in the reference users and other seed users in the reference users; and
program instructions, in response to determining that the deviation degree exceeds a predetermined threshold, to adjust a contribution of the first kind of data of the first seed user to the obtaining of the trait.

14. A computer system in accordance with claim 9, wherein program instructions to determine one or more reference users similar to the target user comprises:
program instructions to determine the reference users from non-seed users, wherein each of the non-seed users is a user with the first kind of data insufficient to obtain the trait.

15. A computer system in accordance with claim 14, wherein program instructions to obtain the trait of the target user based on the first kind of data of the reference users comprise:
program instructions to group non-seed users in the reference users based on the second kind of data of the non-seed users in the reference users;
program instructions to aggregate the first kind of data of the non-seed users in the reference users based on the grouping; and
program instructions to obtain the trait based on the aggregated first kind of data.

16. A computer system in accordance with claim 9, further comprising:
program instructions, in response to determining that the first kind of data of the target user is sufficient to obtain the trait of the target user, to store the first kind of data of the target user for use in obtaining the trait of a further user.
